(19) United States
(12) Patent Application Publication
(10) Pub. No.: US 2007/0027031 A1
(43) Pub. Date: Feb. 1, 2007

(54) Catalyst material comprising transition metal oxide

(75) Inventors: Shinichi Ikeda, Ibaraki (JP); Yoshiyuki Yoshida, Ibaraki (JP); Norio Umeyama, Ibaraki (JP); Hideo Abe, Kanagawa (JP); Yasuhito Tanaka, Kanagawa (JP); Ariyoshi Ogasawara, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: National Inst. of Adv. Indus. Science and Tech, Tokyo (JP); SFC CO., LTD., Kanagawa (JP)

(21) Appl. No.: 10/555,100

(22) PCT Filed: Apr. 30, 2004
(86) PCT No.: PCT/JP04/06311

§ 371 Date: Aug. 23, 2006

(30) Foreign Application Priority Data
May 2, 2003 (JP) 2003-127146

(51) Int. Cl. B01J 23/00

(52) U.S. Cl. 502/302; 502/303; 502/304; 502/300

(57) ABSTRACT

A metal oxide catalyst material which comprises one or more of transition metal elements having a 4d shell electron or a 5d shell electron as an electron bearing the electroconductivity thereof; and a catalyst for treating a combustion exhaust gas comprising the catalyst material. The contact of an exhaust gas with the metal oxide catalyst material allows harmful substances such as nitrogen oxides contained in the following exhaust gases to be decomposed or removed as a whole and simultaneously. The catalyst material and the catalyst can be suitably used for removing harmful materials such as nitrogen oxides, hydrocarbons, diesel particulates, carbon monoxide, carbon dioxide and dioxins, which are discharged from an automobile, a ship, an airplane, a glass melting furnace, a steel product heating furnace, a coke furnace, a cement firing furnace, a steel sintering furnace, a high temperature furnace such as a converter, an incinerator, a rocket engine, a thermal power station, a boiler, a plant for producing a catalyst or a chemical such as phosphoric acid, facilities for treating a metal or petroleum, a petroleum stove, a gas range or the like.

### TECHNICAL FIELD

This invention relates to a technique for the removal of such harmful substances as nitrogen oxides, hydrogen carbide, diesel particulates, carbon monoxide, carbon dioxide, and dioxins which are emitted from motorcars, vessels, airplanes, glass blast furnaces, steel heating furnaces, shaft hot-air furnaces, coke ovens, cement kilns, steel sintering furnaces, high temperature furnaces like converters, garbage furnaces, rocket engines, thermal power plants, boilers, mills for manufacturing nitric acid and other chemicals and catalysts, facilities for processing metals and petroleum oil, oil stoves, and gas ranges, i.e. devices utilizing combustion of fossil fuels like coal natural gas, and petroleum.

### BACKGROUND ART

The waste gases of combustion emitted from automobiles, vessels, airplanes, and rockets furnished with internal combustion engines as drive sources or blast furnaces, incinerators, thermal power plants, and crude oil refining facilities adapted to acquire high temperature environments by the combustion of a varying substance contain components which are copiously varied by the kind of material to be burned and the kind of environment of the combustion. Mainly, nitrogen oxides, sulfur oxides, halogenated carbon compounds, hydrogen carbide, particulate carbon compounds, carbon dioxide, and dioxins have been known as such components of the waste gases. Since they invariably have a very large load on the environment, the regulations directed toward reducing such waste gases have come to be enforced recently on the global scale. Particularly, the existence of nitrogen in the air never fails to result in forming nitrogen oxides (NOx) at the site of combustion in the air, without reference to the degree of abundance of the nitrogen content.

The methods used for reducing the amounts of emission of nitrogen oxides NOx are broadly classified under two kinds, (1) the removal of the NOx formed in the waste gases and (2) the repression of the formation of NOx by the improvement of the technique of combustion. The methods of the kind of (1) are divided into the dry methods and the wet methods. The dry method resides in reducing the NOx till detoxication and the wet method resides in detoxicating the NOx by causing it to be absorbed in a liquid thereby converting it into a nitrate as a by-product. The wet method has enjoyed development of a research mainly in the removal of NOx in boilers and heating furnaces. Meanwhile, the dry method has enjoyed development of a research regarding the disposal of NOx in the exhaust gas of an automobile, for example, because this method yields no by-product and proves effective for a mobile source of emission and a small source of emission.

In the class of dry methods, particularly the method called catalytic reduction is known. This method consists in adding together a gas containing NO or NO₂ and a reducing gas such as methane, carbon monoxide, or ammonia and reducing NO₂ into NO and NO into innocuous N₂ by virtue of a catalytic action. The method of catalytic reduction is known in two versions, a selective reduction method and a non-selective reduction method. When a-gas containing NOx, for example, and ammonia added thereto as a reducing agent are together subjected to the action of a Pt catalyst at 200-300° C., the NOx in the gas is selectively reduced into N₂. As regards the exhaust gas as from a large boiler in a thermal power plant, for example, the method of ammonia selective reduction (SCR method) using an oxide-based catalyst such as V₂O₅+TiO₂ has been reduced to practice. Such noble metals as Pd and Rh and Pt as well have high catalytic effects. Their catalytic activities, however, are lost in the presence in such a small amount as several ppm of SO₂, a substance which never fails to occur when a fossil fuel other than natural gas is burnt.

In this state of affairs, a research directed toward detoxicating the nitrogen oxides in the exhaust gas from a gasoline engine using gasoline as a fuel by the use of a noble metal catalyst has been energetically pursued. As regards the repression of nitrogen oxides, for example, the technique for reducing the nitrogen oxides NOx formed from nitrogen and oxygen in the air in consequence of the high temperature combustion in an engine till nitrogen by using a catalyst called a three-way catalyst developed for the disposal of the exhaust gas of an automobile furnished with a gasoline engine and using unburnt hydrocarbon and carbon monoxide in the exhaust gas as a reducing agent has been widely utilized. The term “three-way catalyst” as used herein refers to a catalyst which results from attaching as to a refractory ceramic substrate a noble metal such as Pt, Pd, or Rh dispersed and deposited in the form of ultra-fine particles on the surface of an alumina. The term “ternary” refers to the simultaneous removal of hydrogen carbide, carbon monoxide, and nitrogen oxides. This three-way catalyst, however, necessitates a condition in which the ratio of air and gasoline supplied to the engine (air-fuel ratio) may be so controlled as to balance the amount of nitrogen oxides (oxidizing agent) and the amounts of hydrogen carbide and carbon monoxide (reducing agent).

As the engine for an automobile, the diesel engine has been widely used on account of excellent fuel cost and inexpensive fuel. The diesel engine, unlike the gasoline engine, suffers the exhaust gas thereof to entrain such diesel particulates (DP) as particulate hydrogen carbide and sulfuric acid oxide in large amounts. The regulation of these diesel particulates, as harmful substances different from Nox, has been being reinforced in recent years.

Teraoka et al., for example, have reported that a perovskite-based oxide is an effective catalyst capable of simultaneously removing DP and NOx in the exhaust gas of a diesel engine and that La_{0.9}K_{0.1}Cu_{0.7}V_{0.3}Ox (temperature range: 300° C.-400° C.), among other perovskite-based oxides conceivable, exhibits the highest activity (Applied Catalysis B: Environmental 5, L181-L185 (1995)). In this case, DP functions as a reducing agent and effects removal of NOx at a ratio of removal of about 55% at 390° C. As concerns the perovskite-based oxide, JP-A HEI 11-169711 “Exhaust gas purifying complex catalyst” reports LaCoO₃. This compound does not function to remove NOx but rather functions to oxidize NO and the invention concerns a method for removing NO₂ with metallic Ir which is another catalyst by separately using a hydrocarbon as a reducing agent. Further, CoGa₂O₄ and NiGa₂O₄ both of a spinel structure are reported to have successfully reduced NO gas even at a high oxygen concentration when C₂H₄ was used as a reducing agent (JP-A HEI 7-185347 “Method for production of oxide catalyst material”). The techniques mentioned above invariably resort to use of a transition metal oxide and, unlike a method of direct decomposition, have a large characteristic that the transition metals in the oxides are of the 3d electron type. The diesel engine by nature has DP and NOx in the relation of trade-off When an effective NOx catalyst is available, the diesel engine is enabled to realize its inherent high efficiency.

The methods of catalytic reduction mentioned above, however, are not enabled effectively to render Nox harmless unless a reducing agent and a catalyst such as Pt are both present constantly. The exhaust gas of a lean-burn engine of the highly efficient combustion method (the exhaust gas of a gas turbine, a diesel engine, or a lean-burn gasoline engine) does not allow application of a three-way catalyst embodying a method of non-selective reduction because this exhaust gas contains a large amount of oxygen. Since ammonia which as a reducing agent has been already reduced to practice is poisonous, a study is now underway in search of a catalyzing process of a novel principle. Specifically, the desirability of developing a practical catalyst for the removal of NOx of the direct decomposition type that has no need for a reducing agent, has been finding recognition.

The technical developments directed toward simple removal of nitrogen oxides from the exhaust gas emanating from automobiles, vessels, airplanes, glass crucible furnaces, steel heating furnaces, hot blast stoves, coke ovens, cement firing furnaces, steel sintering furnaces, high temperature furnaces such as steel converters, refuse furnaces, rocket engines, thermal power plants, boilers, plants for manufacturing nitric acid, other chemicals, and catalysts, facilities for processing metals and petroleum oils, kerosine stoves, and gas ranges which utilize the combustion of fossil fuels such as coal, natural gas, petroleum oil have induced various methods mentioned above. Some of these methods have been already reduced to practice. Owing to the absence of a NOx catalyst of the direct decomposition type which is theoretically the best approach, the problem of inevitably using ammonia which is a poisonous reducing agent and the problem of failing to utilize the most suitable combustion conditions have persisted to date.

This invention, therefore, is aimed at providing a material which functions as a direct decomposition type catalyst obviating the necessity for using ammonia, i.e. a noxious reducing agent, and a catalyst formed of this catalytic material and used for disposing of the exhaust gas of combustion.

### DISCLOSURE OF THE INVENTION

The present inventors, in view of the task mentioned above, have pursued an extensive study in search of an exhaust gas filter functioning as a catalyst of the type of direct decomposition of NOx with a varying kind of transition metal oxide. As a result, they have discovered that a metal oxide containing a transition metal element which has a 4d orbital electron or a 5d orbital electron as an electron responsible for electric conduction possesses a high capacity for direct decomposition of NOx and perfected this invention.

The metal oxide catalyst material according to this invention contains at least one kind of transition metal element which has a 4d orbital electron or a 5d orbital electron as an electron responsible for electric conduction.

The metal oxide catalyst material according to this invention also contains at least one kind of alkali metal element and at least one kind of transition metal element which has a 4d orbital electron or a 5d orbital electron as an electron responsible for electric conduction.

The metal oxide catalyst material according to this invention further contains at least one kind of alkaline earth metal element and at least one kind of transition metal element which has a 4d orbital electron or a 5d orbital electron as an electron responsible for electric conduction.

The metal oxide catalyst material according to this invention further contains at least one kind of rare earth metal element and at least one kind of transition metal element which has a 4d orbital electron or a 5d orbital electron as an electron responsible for electric conduction.

The metal oxide catalyst material according to this invention further contains at least one kind of metal element selected from the group consisting of bismuth (Bi), tin (Sn), lead (Pb), germanium (Ge), silicon (Si), aluminum (Al), gallium (Ga), indium (In) and zinc (Zn) and at least one kind of transition metal element which has a 4d orbital electron or a 5d orbital electron as an electron responsible for electric conduction.

The metal oxide catalyst material according to this invention further contains at least one member selected from the group consisting of the elements of tungsten (W), molybdenum (Mo), niobium (Nb), zirconium (Zr), hafnium (Hf), ruthenium (Ru), iridium (Ir), rhodium (Rh), palladium (Pd), platinum (Pt), gold (Au), silver (Ag) and rhenium (Re) as a transition metal element which has a 4d orbital electron or a 5d orbital electron as an electron responsible for electric conduction.

The metal oxide catalyst material according to this invention further possesses an MO₆ octahedron or MO₄ tetrahedron, each formed of a transition metal element M and an oxygen O, or both, as component elements of a crystal structure.

The metal oxide catalyst material according to this invention further possesses a composition of the formula, Aₙ₊₁BₙO₃ₙ₊₁(n=1, 2, 3, 4), has as an A element one kind of metal selected from the group of the elements of calcium (Ca), strontium (Sr), barium (Ba), lanthanum (La) and tin (Sn), and has as a B element one kind of metal selected from the group of elements of tungsten (W), molybdenum (Mo), niobium (Nb), zirconium (Zr), hafnium (Hf), ruthenium (Ru), Iridium (Ir), rhodium (Rh) and platinum (Pt).

The metal oxide catalyst material according to this invention further possesses any one crystal structure selected from among perovskite structure, layered perovskite structure, pyrochroite structure and spinel structure.

The metal oxide catalyst material according to this invention further possesses electroconductivity.

The catalyst for treating a combustion exhaust gas according to this invention comprises a metal oxide catalyst material of this invention molded in a form of bulk, a thin film, a thick film and powder.

The catalyst for treating a combustion exhaust gas according to this invention further comprises a metal oxide catalyst material of this invention deposited on a base material formed of at least one material selected from among simple metals, intermetallic compounds and insulating ceramic substances.

The aforementioned metal oxide catalyst material of this invention, on contacting an exhaust gas, is enabled to decompose directly the nitrogen oxides and remove 100% of NOx present in the exhaust gas.

It can be also applied to a method for rendering harmless by decomposition, reduction and oxidation of carbon monoxide, carbon dioxide, hydrogen carbide, diesel particulates, dioxins (polydibenzofuran chloride and coplanar PCB), and chlorofluorocarbon besides nitrogen oxides. Even in a use other than the use for the catalyst intended to dispose of the combustion exhaust gas, it can be expected to manifest the function of a catalyst so long as the essential mode of embodiment is not different from that of this invention.

### BRIEF DESCRIPTION OF THE DRAWINGS

FIG. 1 is a conceptual diagram of an exhaust gas filter using a metal oxide catalyst material of Example 1.

FIG. 2 is a conceptual diagram of a system for determining the amount of NOx.

FIG. 3 is a graph showing the time course change of NO concentration at room temperature due to an exhaust gas filter using a metal oxide catalyst material of Example 1.

FIG. 4 is a graph showing the relation between the NO concentration and the NOx concentration due to an exhaust gas filter according to Example 1.

FIG. 5 is a graph showing the relation between the reaction temperature, the NO concentration and the NOx concentration due to an exhaust gas filter according to Example 2.

### BEST MODE OF EMBODYING THE INVENTION

The metal oxide catalyst material of this invention is characterized by containing at least one kind of transition metal element having a 4d orbital electron or a 5d orbital electron as an electron responsible for electric conduction. It possesses a crystal structure having a MO₆ octahedron or MO₄ tetrahedron, each formed of a transition metal element M and an oxygen O, or both as component elements thereof.

As the transition metal element mentioned above, any one member selected from the group consisting of the elements, tungsten (W), molybdenum (Mo), niobium (Nb), zirconium (Zr), hafnium (Hf), ruthenium (Ru), iridium (Ir), rhodium (Rh), palladium (Pd), platinum (Pt), gold (Au), silver (Ag), and rhenium (Re) proves advantageous because of high catalytic activity.

The metal oxide catalyst material of this invention which contains a transition metal element having a 4d orbital electron or a 5d orbital electron as an electron responsible for electric conduction and an alkali metal element proves advantageous because of high catalytic activity. As concrete examples of the material, Li₂RuO₃, LiRuO₂, NaₓWO₃, NaₓPt₃WO₃, Li₂RhO₂, NaRhO₂, Na₂IrO₃, Na₂PtO₃, Li₂PtO₃, etc. may be cited.

Otherwise, the metal oxide catalyst material which contains a transition metal element having a 4d orbital electron or a 5d orbital electron as an electron responsible for electric conduction and an alkaline earth metal element is an advantageous composition because it gives rise to a highly effective catalytic activity.

As concrete examples of this composition, SrZrO₃, Sr₂ZrO₄, SrHfO₃, Sr₂HfO₄, CaHfO₃, Sr₂RhO₄, SrRuO₃, CaRuO₃, BaRuO₃, Sr₂RuO₄, Sr₃Ru₂O₇, SrIrO₃, CaIrO₃, BaIrO₃, SrMoO₃, CaMoO₃, BaMoO₃, Sr₂MoO₄, Sr₃MoO₇, SrMoO₄, CaMoO₄, BaMoO₄, Sr₃MoO₆, Sr₃Pt₂O₇, Ba₃Pt₂O₇, Sr₂IrO₄, Sr₄IrO₆, Sr₄PtO₆, etc. may be cited.

The metal oxide catalyst material which contains a transition metal element having a 4d orbital electron or a 5d orbital electron as an electron responsible for electric conduction and a rare earth metal element also gives rise to a highly effective catalyst activity.

As concrete examples of this material, LaRuO₃, LaRhO₃, Lu₂Ru₂O₇, La₄Ru₆O₁₉, Lu₂Ir₂O₇, La₄Re₆O₁₉, etc. may be cited.

Further, the metal oxide catalyst material containing a transition metal element having a 4d orbital electron or a 5d orbital electron as an electron responsible for electric conduction and a metal element selected from the group consisting of bismuth (Bi), tin (Sn), lead (Pb), germanium (Ge), silicon (Si), aluminum (Al), gallium (Ga), indium (In), and zinc (Zn) has given rise to a highly effective catalytic activity. As concrete examples of this material, Bi₂Ru₂O₇, Bi₃Ru₃O₁₁, Bi₂Ir₂O₇, and SnHfO₃ may be cited.

The metal oxide catalyst material having a composition of Aₙ₊₁BₙO₃ₙ₊₁(n=1, 2, 3, 4) and containing as the A element one kind of metal selected from the group consisting of calcium (Ca), strontium (Sr), barium (Ba), lanthanum (La), and tin (Sn) and as the B element one kind of metal selected from the group consisting of tungsten (W), molybdenum (Mo), niobium (Nb), zirconium (Zr), hafnium (Hf), ruthenium (Ru), iridium (Ir), rhodium (Rh), and platinum (Pt) manifests a more highly effective catalytic activity.

As concrete examples of this material, Sr₂RhO₄, SrRuO₃, CaRuO₃, BaRuO₃, LaRuO₃, LaRhO₃, Sr₂RuO₄, Sr₃Ru₂O₇, SrIrO₃, CaIrO₃, BaIrO₃, SrMoO₃, CaMoO₃, BaMoO₃, SnHfO₃, Sr₂MoO₄, Sr₃Mo₂O₇, Sr₃Pt₂O₇, Ba₃Pt₂O₇, Sr₂IrO₄, SrZrO₃, Sr₂ZrO₄, SrHfO₃, Sr₂HfO₄, and CaHfO₃ may be cited.

When the metal oxide catalyst material of this invention has any crystal structure selected from among perovskite structure, lamellar perovskite structure, pyrochroite structure, and spinel structure, it may be in a simple phase or in a phase of a mixture of a plurality of crystal structures.

As concrete examples of the metal oxide catalyst material of this invention which has a perovskite structure, SrRuO₃, CaRuO₃, LaRuO₃, LaRhO₃, SrIrO₃, SrMoO₃, CaMoO₃, BaMoO₃, SnHfO)₃, SrZrO₃, SrHfO₃, and CaHfO₃ may be cited.

As concrete examples of the metal oxide catalyst material of this invention which has a lamellar structure, Sr₂RhO₄, SrRuO₄, Sr_{3Ru}₂O₇, Sr₂MoO₄, Sr₃Mo₂O₇, Sr₃Pt₂O₇, Ba₂Pt₂O₇, Sr₂IrO₄, Sr₂ZrO₄, and Sr₂HfO₄ may be cited.

As concrete examples of the metal oxide crystal material of this invention which has a pyrochroite structure, Bi₂Rh₂O₇, Bi₂Ru₂O₇, Lu₂Ru₂O₇, Bi₂Ir₂O₇, and Lu₂Ir₂O₇ may be cited.

As a concrete example of the metal oxide catalyst material of this invention which has a spinel structure, ZnRh₂O₄ may be cited.

The metal oxide catalyst material of this invention is composed of a transition metal element having a 4d orbital electron or a 5d orbital electron as an electron responsible for electric conduction and other metal element. The component elements of the composition do not need to be in a stoichiometric ratio. Even when they are in a non-stoichiometric ratio involving a deviation of about ∀(10%), the composition poses no particular problem in the accomplishment of the task of this invention so long as it incorporates therein a perovskite structure, a lamellar perovskite structure, a pyrochroite structure, or a spinel structure.

For the production of the metal oxide catalyst material of this invention, any of the methods of production including a solid phase reaction firing method, a sol≅gel method using a metal alkoxide, a melting method, and a flux method can be used. To be specific, the metal oxide catalyst material of this invention can be produced by mixing powders of oxide, carbonate, and hydroxide and firing the produced mixture or by evaporating to dryness as by spray drying the aqueous solution of a mixture of acetate and nitrate and decomposing and firing the produced dry mixture. The production can be also attained by a method which comprises adding the aqueous solution of the mixture and a precipitating medium such as a nitrate, recovering the resultant precipitate, and firing the recovered precipitate.

For the purpose of enabling the metal oxide catalyst material of this invention to acquire a perovskite structure, a lamellar perovskite structure, a pyrochroite structure, or a spinel structure, the firing temperature is preferred to be not lower than (Celsius 800)° C. The firing temperature is preferred to be higher than the working temperature of the catalyst for the purpose of enabling the catalyst to retain stability and durability during the course of use. If the firing is made at a temperature exceeding (Celsius 1500)° C., the excess will possibly result in densifying the precipitate being fired and rendering difficult the impartation of high catalytic activity to the fired product.

The metal oxide catalyst material of this invention produced as described above may be used per se as a catalyst for the exhaust gas. The catalyst to be used for disposing of the exhaust gas is preferred to have a large surface area for contact with the gas. Thus, the metal oxide catalyst material of this invention may be used as pulverized into a powdery form having an average particle diameter approximately in the range of 1 :m-100 :m. Optionally, the metal oxide catalyst material of this invention may be reduced to a powdery form having a prescribed average particle diameter, the resultant powder per se or the paste manufactured by combining this powder with a proper binder compression-molded in the form of a bulk such as pellets, a thin film, or a thick film, and the produced mold used as a catalyst for disposing of a combustion exhaust gas. Incidentally, while the working examples of this invention used such powders measuring about 20—about 100 :m in average particle diameter, finer powders measuring about 1.0 :m in average particle diameter may be used without posing any problem regarding the effect of this invention.

The binder to be used effectively for the paste may be freely selected from among various kinds which satisfy the sole condition that they are incapable of reacting with the metal oxide catalyst material of this invention at a temperature of not higher than 1000° C. For example, the materials formed of such compounds as SiO₂, Na₂O, CaO, and B₂O₃ or of mixtures of these compounds are available as advantageous binders.

A filter-like product obtained by applying the pasty agent containing the metal oxide catalyst material of this invention to a monolithic structure or a honeycomb structure manufactured as from alumina, cordierite, or silicon carbide and firing the resultant composite may be used as a filter for disposing of a combustion exhaust gas.

The pasty metal oxide catalyst, depending on the purpose of use, may be deposited on not only the aforementioned insulating ceramic substance but also intermetallic compounds such as stainless steel and high melting simple metals such as zirconium, platinum tungsten, titanium, and nickel, Though the amount of this catalyst to be deposited depends on the shape and the size of the base material, it is only required to be sufficient for uniformly covering the surface of the base material.

When the transition metal catalyst material of this invention is used as a catalyst for disposing of a combustion exhaust gas, the specific surface area thereof is not less than 10⁻³ m²/g and preferably in the range of 10⁻²-10⁻³ m²/g. If the specific surface area exceeds 10² m²/g, the overage will result in suffering the crystal grains to become unduly small and, in a high temperature environment (mainly 200° C.-700° C.) which is a working condition for this invention, induce cohesion of individual crystal grains and decrease the specific surface area. Conversely, if the specific surface area falls short of 10⁻³ m²/g, the shortage will be at a disadvantage in preventing the crystal grains from acquiring the necessary function for a catalyst.

The “harmful substance” in the exhaust gas subjected to the treatment of decomposition by the catalyst of this invention refers to such harmful substances which are represented by hydrogen carbide, diesel particulates, carbon monoxide, carbon dioxide, dioxins (polydibenzo-p-dioxin chloride, polydibenzofibran chloride, and coplanar PCB), precursors of dioxins, and chlorofluorocarbon besides nitrogen oxides. The harmful substances in the exhaust gas which can be catalytically reduced or decomposed owing to the catalytic function contemplated by this invention do not need to be restricted only to the concrete examples enumerated above.

The “nitrogen oxides” to be treated according to this invention mean nitrogen oxides which are present in the exhaust gas and are expressed as NOx.. The nitrogen oxides generally embrace NO and NO₂ and mixtures thereof as well. Often, the nitrogen oxides in the exhaust gas include nitrogen oxides of various oxidation numbers. Thus, the suffix “f” generally has a value of 1-2, though it is not particularly restricted.

By using the aforementioned catalyst according to this invention, it is made possible to have the aforementioned harmful substances, i.e. nitrogen oxides, dioxins (polydibenzo-p-dioxin chloride, polydibenzofuran chloride, and coplanar PCS), precursors of dioxins, and chlorofluorocarbon rendered harmless by dint of catalytic reduction or decomposition.

Since the catalyst of this invention used for the disposal of the combustion exhaust gas has a temperature range ideal for the sake of catalytic activity as mentioned above, the use of the metal oxide catalyst material adjusted in advance to acquire electric conductivity enables the catalyst for the disposal of the combustion exhaust gas to be so controlled as acquire this ideal temperature range by feeding an electric current to the catalyst itself. As concrete examples of the metal oxide catalyst material of this invention which possesses electric ,conductivity, W₂O₅, MoO₂, Mo₂O₅, NbO₂, NbO, Rh₂O₃, RhO₂, RuO₂, IrO₂, PdO, PtO₂, Au₂O₃, AgO, Ag₂O, Re₂O₃, ReO₂, Re₂O₅, ReO₂, Sr₂RhO₄, Bi₂Rh₂O₇, SrRuO₃, CaRuO₃, BaRuO₃, LaRuO₃, Sr₂RuO₄, Sr₃Ru₂O₇, Bi₂Ru₂O₇, Lu₂Ru₂O₇, La₄Ru₆O₁₉, Bi₃Ru₃O₁₁, Li₂RuO₃, SrIrO₃, CaIrO₃, BaIrO₃, Bi₂Ir₂O₇, Lu₂Ir₂O₇, La₄Re₆O₁₉, SrMoO₃, CaMoO₃, BaMoO₃, NaxWO₃, Sr₂MoO₄, Sr₃Mo₂O₇, Sr₃Pt₂O₇, Ba₃Pt₂O₇, NaxPt₃O₄, LiRhO₃, NaRhO₂, Na₂IrO₃, Na₂PtO₃, LiPtO₃, LiRuO₂and Li₂RuO₃ may be cited.

The catalyst of this invention for the disposal of the combustion exhaust gas enables the nitrogen oxides to be directly decomposed by contact with the catalyst without requiring addition of a reducing agent such as methane, carbon monoxide, or ammonia to the exhaust gas. This fact constitutes itself one of the salient advantages of this invention.

The contact of the catalyst for the disposal of the combustion exhaust gas with the exhaust gas can be accomplished with a packed bed type or tray type fixed bed flow reactor universally known in the trade or a fluidized bed type reactor making full use the advantage of the catalyst of this invention in manifesting high activity per unit weight. This invention does not need to be particularly restricted to this mode of embodiment but may be modified in various practical modes which suit the kind and the scale of the source of exhaustion.

### EXAMPLES

Now, this invention will be described more specifically below with reference to working examples. This invention is not limited to these examples.

### Example 1

SrCO₃ (powder, 99,99%) and RuO₂ (powder, 99.90%) were mixed at a molar ratio of 2:1, thoroughly mixed finely in an agate mortar, and subsequently sintered in the air at 900° C. for 24 hours. The sinter was again pulverized and mixed and fired again in the air at 1200° C. for 24 hours to obtain a powdered metal oxide catalyst material of Example 1.

A metal oxide catalyst material paste of Example 1 was obtained by thoroughly mixing the resultant Sr₂RuO₄, a binder powder composed of silicon oxide, sodium oxide, calcium oxide, and boron oxide, and water as a solvent. This paste was applied to steel wool and they were together fired in the air at 860° C. for one hour. The produced coated steel wool was sealed in a container made of stainless steel and furnished with a heating unit as illustrated in FIG. 1 to give rise to an exhaust gas filter of Example 1.

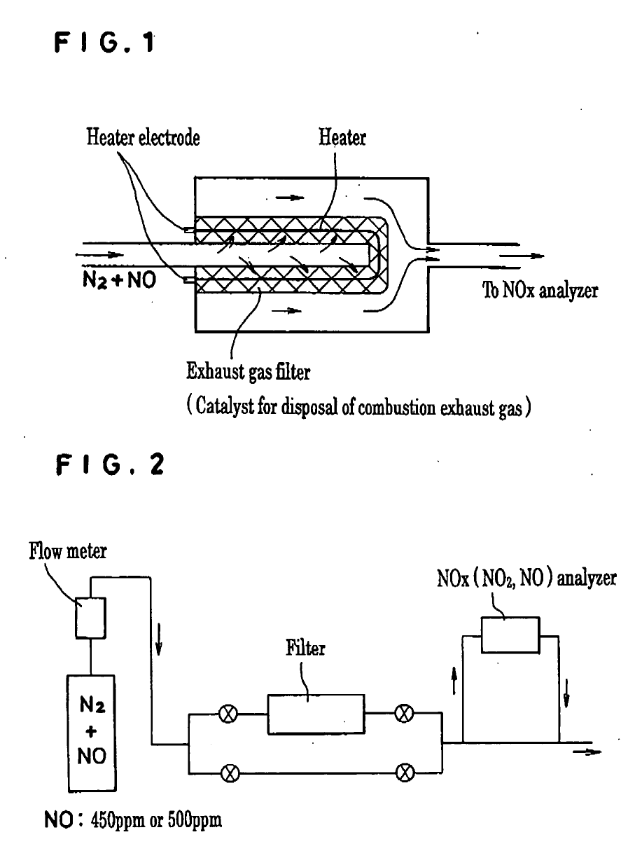

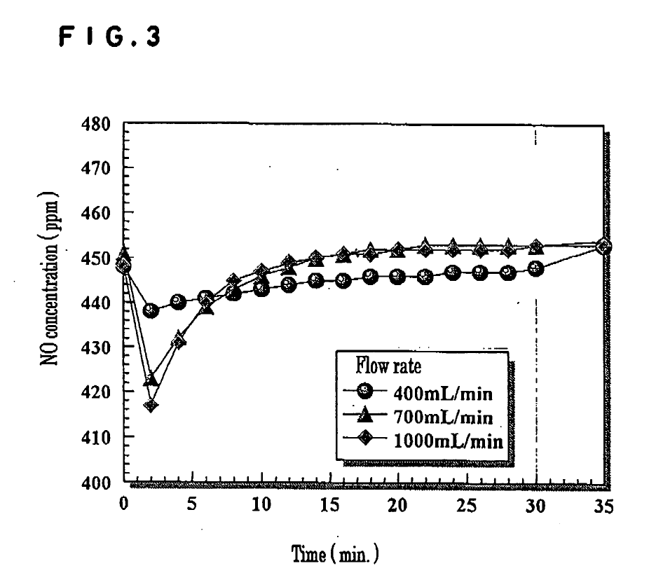

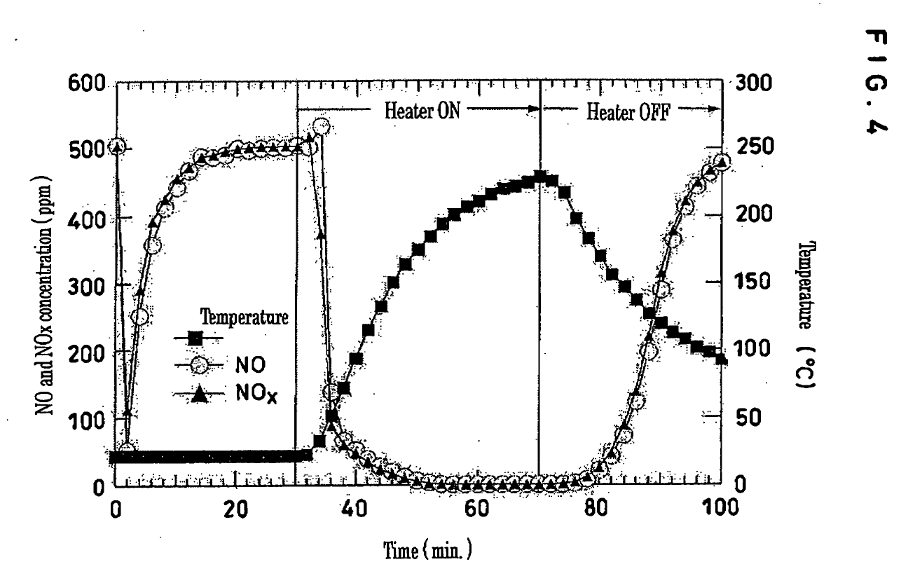

The gas inlet of the exhaust gas filter of Example 1 was connected as illustrated in FIG. 2 to a cylinder for the mixed gas of N₂ and NO (450 ppm or 500 ppm) and the gas outlet thereof was connected to an NOx analyzer, In the system consequently formed, the mixed gas of N₂ and NO was supplied for 35 minutes at room temperature at several flow rates and the gas was tested for NO concentration (FIG. 3).

It is clear from FIG. 3 that the amount of NO showed a slight decrease at 400 mL/min and showed practically no change at 700 mL/min and 1000 mL/min. Within 10 minutes of starting the supply of the gas, the amount of NO was decreased temporarily owing to the presence of air in the exhaust gas filter. This decrease was not due to the substantial effect of catalysis.

Then, the temperature of the filter was elevated by supplying the heater built therein with an electric current and the relation between the concentration of NO, the concentration of the mixed gas of NO and NO₂ (hereinafter referred to as NOx), and the reaction temperature was investigated. The flow rate at this time was 1000 mL/min. In FIG. 4, the lateral axis was the scale of time (minute), the left vertical axis the scale of concentration of each of NO and NOx, and the right vertical axis the scale of temperature. It was 30 minutes later that the supply of the electric current to the heater was started. Incidentally, the displayed temperature was that of the surface of the filter container. The temperature of the catalyst was thought to be about 100° C. higher than the displayed temperature.

As shown in FIG. 4, the concentration of NOx sharply decreased when the temperature approached 100° C. and practically fell to 0 ppm within 45 minutes of starting the application of heat. Since the concentrations of NO and NOx changed in a nearly coinciding state, the difference between the NO concentration and the NOx concentration, namely the concentration of NO₂, was extremely low. The changes occurring in this filter, therefore, indicate that no NO₂ was formed and that the introduced NOx was directly decomposed and converted into N₂ and O₂ by the metal oxide catalyst material of Example 1 of this invention in the absence of a reducing agent. When the electric current supplied to the heater was zeroed 70 minutes thereafter, the NOx concentration remained at 0 ppm for about 10 minutes. As the temperature fell amply, the NOx concentration slowly rose. The result completely denies the stipulate that the electric current flowing to the heater built in the filter was the essential cause for the Nox decrease, That is, the result strongly indicates that the NOx was directly reduced and rendered harmless owing to the temperature of about 200° C. and the catalytic function possessed by the transition metal oxide material.

### Example 2

A metal oxide catalyst material paste of Example 2 was obtained by thoroughly mixing RuO₂ (powder, 99.9%), a binder powder composed of silicon oxide, sodium oxide, calcium oxide, and boron oxide, and water as a solvent. This paste was applied to steel wool and they were sintered together in the air at 860° C. for one hour. The coated steel wool was sealed in a container made of stainless steel and provided with a heating unit as illustrated in FIG. 1 to give rise to an exhaust gas filter of Example 2.

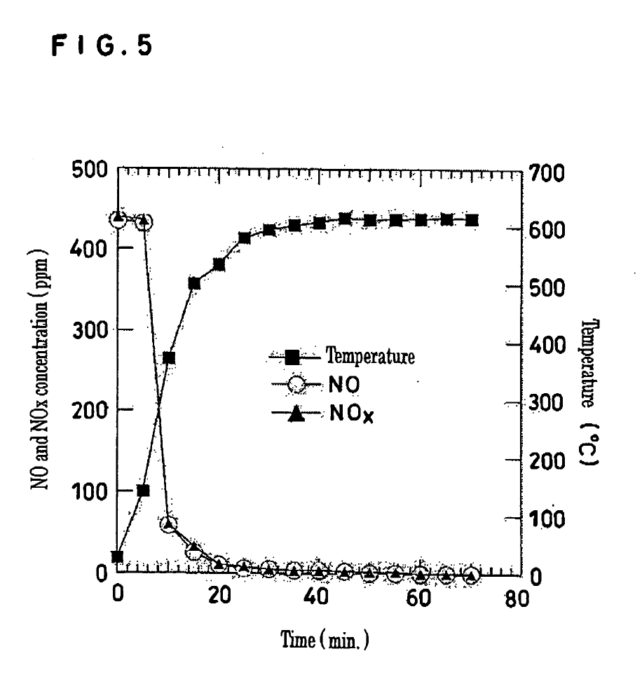

Then, the temperature of the filter was elevated by supplying the heater built therein with an electric current and the relation between the concentration of NOx and the reaction temperature was investigated. The flow rate at this time was 1000 mL/min. In FIG. 5, similarly to FIG. 4, the lateral axis was the scale of time (minute), the left vertical axis the scale of concentration of each of NO and Nox, and the right vertical axis the scale of temperature. The displayed temperature resulted from directly measuring the temperature of the catalyst,

As shown in FIG. 5, the concentration of Nox sharply decreased when the temperature approached 200° C. and it fell practically to 0 ppm 30 minutes thereafter. Since the concentrations of NO and NOx changed in a practically coinciding state, the difference between the NO concentration and the NOx concentration, namely the concentration of NO₂, was extremely low, The changes occurring in this filter, therefore, indicate that no NO₂ was formed and that the introduced NOx was directly decomposed and converted into N₂ and O₂ by the metal oxide catalyst material of Example 2 of this invention in the absence of a reducing agent.

As shown in FIG. 3-FIG. 5, the filter having the metal oxide catalyst material of this invention deposited thereon has been demonstrated to be usable in a technique for easy removal of nitrogen oxides from the exhaust gas emanating from automobiles, vessels, airplanes, glass crucible furnaces, steel heating furnaces, hot blast stoves, coke ovens, cement firing furnaces, steel sintering furnaces, high temperature furnaces such as converters, refuse furnaces, rocket engines, thermal power plants, boilers, plants for manufacturing nitric acid, other chemicals, and catalysts, facilities for processing metals and petroleum oils, kerosine stoves, and gas ranges which utilize the combustion of fossil fuels such as coal, natural gas, petroleum oil.

Industrial Applicability

A metal oxide catalyst material which is a compound containing at least one metal element and is characterized by at least one of the metal elements being a transition metal having a 4d orbital electron or a 5d orbital electron functions as a direct decomposition type catalyst capable of removing 100% of the NOx in the exhaust gas.

It can be applied to a method for rendering harmless by decomposition, reduction, and oxidation carbon monoxide, carbon dioxide, hydrogen carbide, diesel particulates, dioxins (polydibenzofuran chloride and coplanar PCB), and chlorofluorocarbon besides nitrogen oxides. Even in uses other than the uses set forth in claims, it can be expected to fulfill the function of a catalyst when the modes of embodiment do not substantially differ from the mode of embodiment of this invention.

1. The metal oxide catalyst material which contains at least one kind of transition metal element having a 4d orbital electron or a 5d orbital electron as an electron responsible for electric conduction.

2. The metal oxide catalyst material which contains at least one kind of alkali metal element and at least one kind of transition metal element having a 4d orbital electron or a 5d orbital electron as an electron responsible for electric conduction.

3. The metal oxide catalyst material which contains at least one kind of alkaline earth metal element and at least one kind of transition metal element having a 4d orbital electron or a 5d orbital electron as an electron responsible for electric conduction.

4. The metal oxide catalyst material according to this invention further which contains at least one kind of rare earth metal element and at least one kind of transition metal element having a 4d orbital electron or a 5d orbital electron as an electron responsible for electric conduction.

5. The metal oxide catalyst material according to this invention further which contains at least one kind of metal element selected from the group consisting of bismuth (Bi), tin (Sn), lead (Pb), germanium (Ge), silicon (Si), aluminum (Al), gallium (Ga), indium (In) and zinc (Zn) and at least one kind of transition metal element having a 4d orbital electron or a 5d orbital electron as an electron responsible for electric conduction.

6. The metal oxide catalyst material according to claim 1, which contains at least one member selected from the group consisting of the elements of tungsten (W), molybdenum (Mo), niobium (Nb), zirconium (Zr), hafnium (Hf), ruthenium (Ru), iridium (Ir), rhodium (Rh), palladium (Pd), platinum (Pt), gold (Au), silver (Ag) and rhenium (Re) as a transition metal element having a 4d orbital electron or a 5d orbital electron as an electron responsible for electric conduction.

7. The metal oxide catalyst material according to claim 1, which possesses an MO₆ octahedron or MO₄ tetrahedron, each formed of a transition metal element M and an oxygen O, or both, as component elements of a crystal structure.

8. The metal oxide catalyst material according to claim 1, which possesses a composition of the formula, Aₙ₊₁BₙO₃ₙ₊₁(n=1, 2, 3, 4), has as an A element one kind of metal selected from the group of the elements of calcium (Ca), strontium (Sr), barium (Ba), lanthanum (La) and tin (Sn), and has as a B element one kind of metal selected from the group of elements of tungsten (W), molybdenum (Mo), niobium (Nb), zirconium (Zr), hafnium (Hf), ruthenium (Ru), Iridium (Ir), rhodium (Rh) and platinum (Pt).

9. The metal oxide catalyst material according to claim 1, which possesses any one crystal structure selected from among perovskite structure, layered perovskite structure, pyrochroite structure and spinel structure.

10. The metal oxide catalyst material according to claim 1, which possesses electroconductivity.

11. The catalyst for treating a combustion exhaust gas according to claim 1, which comprises a metal oxide catalyst material of this invention molded in a form of bulk, a thin film, a thick film and powder.

12. The catalyst for treating a combustion exhaust gas according to claim 2, which comprises a metal oxide catalyst material of this invention molded in a form of bulk, a thin film, a thick film and powder.

13. The catalyst for treating a combustion exhaust gas according to claim 3, which comprises a metal oxide catalyst material of this invention molded in a form of bulk, a thin film, a thick film and powder.

14. The catalyst for treating a combustion exhaust gas according to claim 4, which comprises a metal oxide catalyst material of this invention molded in a form of bulk, a thin film, a thick film and powder.

15. The catalyst for treating a combustion exhaust gas according to claim 5, which comprises a metal oxide catalyst material of this invention molded in a form of bulk, a thin film, a thick film and powder.

16. The catalyst for treating a combustion exhaust gas according to claim 6, which comprises a metal oxide catalyst material of this invention molded in a form of bulk, a thin film, a thick film and powder.

17. The catalyst for treating a combustion exhaust gas according to claim 7, which comprises a metal oxide catalyst material of this invention molded in a form of bulk, a thin film, a thick film and powder.

18. The catalyst for treating a combustion exhaust gas according to claim 8, which comprises a metal oxide catalyst material of this invention molded in a form of bulk, a thin film, a thick film and powder.

19. The catalyst for treating a combustion exhaust gas according to claim 9, which comprises a metal oxide catalyst material of this invention molded in a form of bulk, a thin film, a thick film and powder.

20. The catalyst for treating a combustion exhaust gas according to claim 10, which comprises a metal oxide catalyst material of this invention molded in a form of bulk, a thin film, a thick film and powder.

21. The catalyst for treating a combustion exhaust gas according to claim 1, which comprises a metal oxide catalyst material of this invention deposited on a base material formed of at least one material selected from among simple metals, intermetallic compounds and insulating ceramic substances.

22. The catalyst for treating a combustion exhaust gas according to claim 2, which comprises a metal oxide catalyst material of this invention deposited on a base material formed of at least one material selected from among simple metals, intermetallic compounds and insulating ceramic substances.

23. The catalyst for treating a combustion exhaust gas according to claim 3, which comprises a metal oxide catalyst material of this invention deposited on a base material formed of at least one material selected from among simple metals, intermetallic compounds and insulating ceramic substances.

24. The catalyst for treating a combustion exhaust gas according to claim 4, which comprises a metal oxide catalyst material of this invention deposited on a base material formed of at least one material selected from among simple metals, intermetallic compounds and insulating ceramic substances.

25. The catalyst for treating a combustion exhaust gas according to claim 5, which comprises a metal oxide catalyst material of this invention deposited on a base material formed of at least one material selected from among simple metals, intermetallic compounds and insulating ceramic substances.

26. The catalyst for treating a combustion exhaust gas according to claim 6, which comprises a metal oxide catalyst material of this invention deposited on a base material formed of at least one material selected from among simple metals, intermetallic compounds and insulating ceramic substances.

27. The catalyst for treating a combustion exhaust gas according to claim 7, which comprises a metal oxide catalyst material of this invention deposited on a base material formed of at least one material selected from among simple metals, intermetallic compounds and insulating ceramic substances.

28. The catalyst for treating a combustion exhaust gas according to claim 8, which comprises a metal oxide catalyst material of this invention deposited on a base material formed of at least one material selected from among simple metals, intermetallic compounds and insulating ceramic substances.

29. The catalyst for treating a combustion exhaust gas according to claim 9, which comprises a metal oxide catalyst material of this invention deposited on a base material formed of at least one material selected from among simple metals, intermetallic compounds and insulating ceramic substances.

30. The catalyst for treating a combustion exhaust gas according to claim 10, which comprises a metal oxide catalyst material of this invention deposited on a base material formed of at least one material selected from among simple metals, intermetallic compounds and insulating ceramic substances.
